(19) United States
(12) Patent Application Publication
(10) Pub. No.: US 2008/0151574 A1
(43) Pub. Date: Jun. 26, 2008

(54) BACK LIGHT UNIT

(76) Inventors: Joong-Wan PARK, Suwon-si (KR); Man-Ho Kim, Suwon-si (KR); Seong-Ha Park, Suwon-si (KR)

Correspondence Address: CHA & REITER, LLC, 210 ROUTE 4 EAST STE 103, PARAMUS, NJ, 07652, US

(21) Appl. No.: 11/958,426

(22) Filed: Dec. 18, 2007

(30) Foreign Application Priority Data
Dec. 20, 2006 (KR) 130904/2006

(51) Int. Cl. F21V 7/04; H01J 9/02

(52) U.S. Cl. 362/612; 362/624; 445/23; 445/58

(57) ABSTRACT

A back light unit and a method of manufacture that can provide a backlight unit suitable for a Liquid Crystal Display (LCD) device includes a bezel, a reflection layer arranged onto the bezel, and a light guide plate disposed on the reflection layer. The reflection layer can be coated onto the bezel, and may include a reflective material that includes a metal such as silver or aluminum, or an alloy thereof. The back light unit can be significantly slimmer than previously known while providing good optical characteristics for a number of different lighting conditions.

### CLAIM OF PRIORITY

This application claims the benefit of priority under 35 U.S.C. §119(a) from a Korean Patent Application filed in the Korean Intellectual Property Office on Dec. 20, 2006 and assigned Serial No. 2006-130904, the entire disclosure of which is hereby incorporated by reference in its entirety.

### BACKGROUND OF THE INVENTION

1. Field of the Invention

The present invention generally relates to a back light unit for portable devices. More particularly, the present invention relates to a back light unit having a Liquid Crystal Display (LCD) device and the optical characteristics associated therewith.

2. Description of the Related Art

Back light units are increasingly being used to provide pictorial information to users. As device having a back light unit become more popular, there are increased demands from consumers to provide back light units that perform well under a variety of different conditions. A typical back light unit includes a Liquid Crystal Display (LCD) device, a light guide plate below the LCD device, at least one light source at a side of the light guide plate, and a reflection film for reflecting light having become incident to the light guide plate from the light source towards the LCD device.

The back light unit may also include a prism sheet for irradiating light of uniform luminance over the entire surface of the LCD device. In addition, a scattering source, such as a diffusion sheet, may be included to irradiate light from a non-uniform luminance source in a uniform manner over the surface of the LCD device.

The back light unit has become a substitute for image devices such as cathode-ray-tube televisions because of back light units weigh significantly less than cathode ray tubes, have a reduced thickness, and are more energy efficient. The reduced size and weight has also led to the use of backlight units in portable communication terminals, such as mobile terminals, or various digital devices including but not limited to personal digital assistants (PDAs), notebook computers, etc. The back light unit can also be used in miniaturized portable digital or mobile terminals due to the structure being such to allow miniaturization without the limitations of other types of displays.

Recent back light units are becoming increasingly slimmer (thinner) for use in portable devices. The back light unit can be made slimmer by reducing the number of diffusion films or prism sheets by pattern optimization for the light guide plate or by using a complex optical film capable of providing at least two functions with a single film.

Accordingly, a complex optical film may provide the functions of previously separate items, serving to act as the diffusion sheet and the prism sheet, or the of the light guide plate and the diffusion sheet, or the of the light guide plate and the prism sheet, or provide all the functions of the diffusion sheet, the prism sheet, and the light guide plate.

However, there is difficulty in producing the aforementioned complex optical film because of degradation in the luminance of light. In other words, the complex optical film, which provides different functions with a single film, cannot satisfy all optical characteristics at the same time at a level that is acceptable in all situations. In other words, the complex optical film is not applicable to products that require optical characteristics higher than a predetermined level.

### SUMMARY OF THE INVENTION

An aspect of the present invention is to address in part at least some of the above problems and/or disadvantages described above, and to provide at least the advantages described below. Accordingly, an aspect of the present invention is to provide a back light unit for a slim (thin) mobile terminal, which can secure stable optical characteristics.

According to one exemplary aspect of the present invention, there is provided a back light unit using a Liquid Crystal Display (LCD) device. The back light unit typically includes a bezel, a reflection layer coated onto the bezel, and a light guide plate disposed on the reflection layer.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a cross-sectional view of a back light unit according to an exemplary embodiment of the present invention;

FIG. 2 is a cross-sectional view of a reflection layer and first and second coating layers coated under and on the reflection layer in the back light unit illustrated in FIG. 1; and

FIG. 3 is a graph illustrating relationships between reflectivities and wavelengths of visible light according to metal materials.

Throughout the drawings, the same drawing reference numerals will be understood to refer to the same elements, features and structures.

### DETAILED DESCRIPTION OF THE INVENTION

The matters defined in the description of a backlight unit according to the present invention, such as a detailed construction and elements, are provided to assist in a comprehensive understanding of an exemplary embodiment of the invention. The drawings and description have been provided for illustrative purposes, and the claimed invention is not limited to the exemplary drawings shown herein and associated description. Accordingly, those of ordinary skill in the art will recognize that various changes and modifications of the embodiment described herein can be made without departing from spirit of the invention and the scope of the appended claims. Also, descriptions of well-known functions and constructions are omitted for clarity and conciseness when their inclusion may obscure appreciation of the invention by a person of ordinary skill in the art.

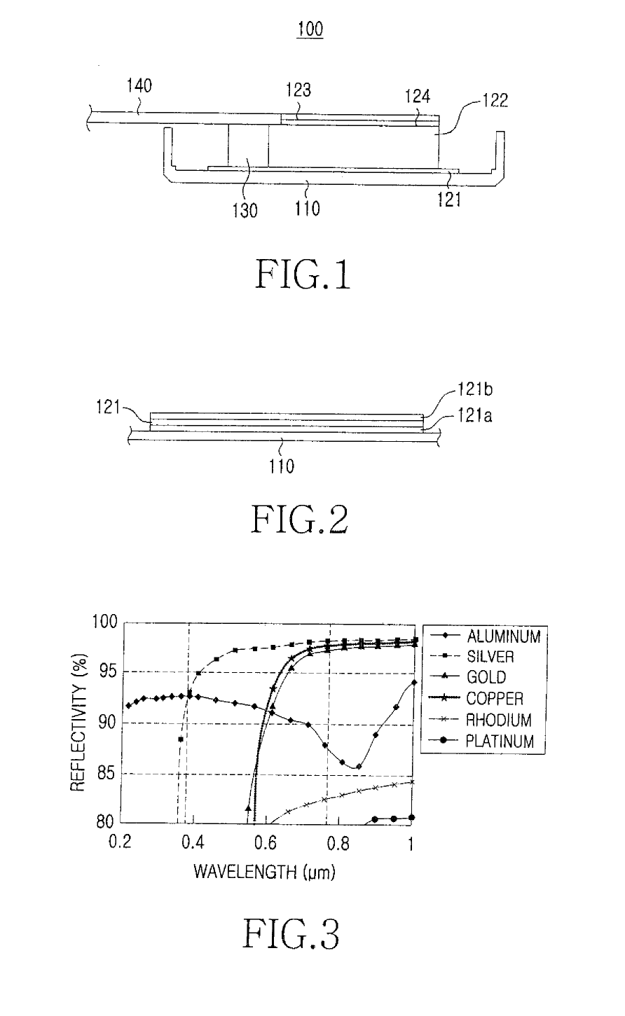

FIG. 1 is a cross-sectional view of a back light unit 100 according to an exemplary embodiment of the present invention. The back light unit 100 typically includes a bezel 110, a reflection layer 121 arranged/coated onto the bezel 110, a light guide plate 122 disposed on the reflection layer 121, a Liquid Crystal Display (LCD) device disposed on the light guide plate 122, at least one light source 130 whose light emitting surface typically faces toward a lateral face of the light guide plate 122, and an optical sheet 124 disposed between the light guide plate 122 and the LCD device 123.

The light guide plate 122 may be connected to the light source 130 and the LCD device 123, for example, by a flexible printed circuit board 140 disposed at a side on the light guide plate 122. A driver may be integrated on the top surface of the flexible printed circuit board 140.

The light source 130 may comprise a Light Emitting Diode (LED) having its light emitting surface face toward the lateral face of the light guide plate 122, so that light for backlighting can be coupled into the light guide plate 122. The light source 130 may also comprise of a plurality of LEDs. A person of ordinary skill in the art understands and appreciates that the described light source is a preference and the device may use other types of light sources.

The optical sheet 124 may typically include a prism sheet and a diffusion film. Lights coupled into the light guide plate 122 are diffused by the optical sheet 124 and light incident to the reflection layer 121 among the diffused lights is reflected to the LCD device 123. In other words, the optical sheet 124 diffuses lights that are coupled into the light guide plate 122 for total reflection and reflects light incident to the reflection layer 121, thereby improving luminance.

The bezel 110 may be made of metal such as, for example, stainless steel. However, the luminance of the bezel 110 composed of stainless steel is 60% of Enhanced Specular Reflector (ESR), which is a multilayer optical film made by 3M corporation that can be used as highly efficient light guide or bulb cavity reflector. ESR provides good visibility across the visible spectrum. The non-metallic thin film construction of ESR which can be provided as a type of reflection sheet, using polyester-group resin having no metal component in a reflection-silver film, and can be used without being processed separately. A person of ordinary skill in the art understands and appreciates that the bezel can be made of other materials not described herein above, or variations of the materials described above. The bezel 110 may also provide the function of a case.

Thus, according to the present invention, by coating the reflection layer 121 on the top surface of the bezel 10, the luminance of light irradiated onto the LCD device 124 can be improved. At person of ordinary skill in the art understands and appreciates that coating is preferred arrangement of the reflection layer 121 on the top surface of the bezel 110, but there are other ways in which the reflection layer can be arranged on the top surface of the bezel that lie within the spirit of the invention and the scope of the appended claims.

FIG. 3 is a graph illustrating relationships between reflectivities and wavelengths of visible light according to metal materials. It is to be understood by a person of ordinary skill in the art that the metal materials have been provided for illustrative purposes and the present invention is not limited to the materials in the graph. Referring to FIG. 3, aluminum marked on the graph with -♦- maintains a reflectivity of 90% or more and 95% or less in a wavelength of 0.2-0.7 μm, while its reflectivity starts being reduced below 90% from a wavelength of about 0.7 μm.

The wavelength of visible light generally ranges between 0.38 0.78 μm and the reflectivity of aluminum is sharply reduced from a wavelength of 0.7 μm.

On the other hand, silver (Ag) marked on the graph with -▪- maintains a constant reflectivity of 90% or more from a wavelength of about 0.38 μm and, in particular, maintains a constant reflectivity of 95% or more from a wavelength of 0.4 μm.

In addition, gold (Au) marked on the graph with -▴-, copper (Cu) marked with . . . × . . . , Rhodium (Rh) marked with -×-, and platinum are typically used for measurement. Gold is typically not suitable to be used in a visible light band because its reflectivity is below 80% in a wavelength of about 0.58 μm or less and a result with respect to copper is similar to that of gold. Rhodium and platinum marked on the graph with -- have a reflectivity of 80-85% from wavelengths of 0.6 μm and 0.85 μm and thus are typically not suitable to be used in the visible light band.

According to the measurement shown in FIG. 3, the reflection layer 121 may have desired reflectivity characteristics in the visible light band using aluminum, silver, or an alloy thereof, but may also be formed by a multi-layered thin film of dielectric materials, different metal materials, or a combination thereof. In other words, the reflection layer 121 can be coated, for example, with a metal material, such as, for example, silver or aluminum or an alloy of silver and aluminum, thereby having optimized efficiency in the visible light band. Preferably, the coating is performed in a similar manner to optical coating, such that a metal material that is typically thermally evaporated in a vacuum chamber is coated onto a face of the bezel 110. However, a person of ordinary skill in the art understands and appreciates that there are other ways to arrange the reflective layer on the face of the bezel 110 that lie within the spirit of the invention and the scope of the appended claims.

FIG. 2 is a cross-sectional view of the reflection layer 121 and first and second coating layers 121a and 121b coated under and on the reflection layer 121 in the example of the back light unit 100 illustrated in FIG. 1. Referring to FIG. 2, the first coating layer 121a, which improves adhesion with the bezel 110, may be formed under the reflection layer 121. The second coating layer 121b, which protects the reflection layer 121, may be formed on a surface of the reflection layer 121.

Still referring to FIG. 2, the first coating layer 121a and the second coating layer 121b may be formed by, for example, coating an epoxy, and in particular, an ultra-violet (UV) epoxy. The second coating layer 121b may be made of, for example, a dielectric material that is transparent in the visible light band, or polymer resin. A person of ordinary skill understands that in the present invention the first and second coating layers 121a, 121b can be made of other materials shown and described herein.

According to the present invention, the back light unit can have a slim structure by forming the reflection layer on a surface of the bezel, which faces the light guide plate, by using, for example, an optical coating. In other words, the reflection layer using an optical coating does not require the use of glass or a sheet as a separate plate and thus can be used in a slim back light unit.

While the invention has been shown and described with reference to an exemplary embodiment thereof, it will be understood by those skilled in the art that various changes in form and details may be made therein without departing from the spirit of the invention and the scope of the appended claims. For example, the arrangement of the reflection layer and the first and second layers 121a, 121b may be arranged other than as shown and described, and may cover portions of the reflective layer, etc.

What is claimed is:

1. A back light unit comprising:
a bezel;
a reflection layer arranged onto the bezel; and
a light guide plate disposed on the reflection layer.

2. The back light unit according to claim 1, wherein the reflection layer comprises a reflective coating.

3. The back light unit of claim 1, wherein at least a portion of the bezel comprises stainless steel.

4. The back light unit of claim 1, further comprising at least one light source for coupling light for backlighting into the light guide plate while facing a lateral face of the light guide plate.

5. The back light unit of claim 2, further comprising at least one light source for coupling light for backlighting into the light guide plate while facing a lateral face of the light guide plate.

6. The back light unit of claim 4, wherein the light source comprises a Light Emitting Diode (LED).

7. The back light unit of claim 1, wherein the reflection layer comprises a metal material selected from the group consisting of silver (Ag), aluminum (AL), and an alloy of silver and aluminum.

8. The back light unit of claim 2, wherein the reflection layer comprises a metal material selected from the group consisting of silver (Ag), aluminum (AL), and an alloy of silver and aluminum.

9. The back light unit of claim 1, wherein the reflection layer comprises a reflective non-metal material.

10. The back light unit of claim 2, wherein the reflection layer comprises a reflective non-metal material.

11. The back light unit of claim 2, further comprising:
a first coating layer disposed between the bezel and the reflection layer; and
a second coating layer disposed onto the reflection layer.

12. The back light unit of claim 8, further comprising:
a first coating layer disposed between the bezel and the reflection layer; and
a second coating layer disposed onto the reflection layer.

13. The back light unit of claim 12, wherein at least one of the first coating layer and the second coating layer comprises an epoxy.

14. A method of making a back light unit, comprising the steps of:
(a) arranging a reflection layer onto a bezel; and
(b) disposing a light guide plate on the reflection layer.

15. The method according to claim 14, wherein the reflection layer comprises a reflective coating that is arranged on the bezel.

16. The method according to claim 15, wherein at least a portion of the bezel comprises stainless steel.

17. The method according to claim 14, further comprising the step of:
(c) arranging a light source for coupling light for backlighting into the light guide plate while facing a lateral face of the light guide plate.

18. The method according to claim 17, further comprising the step of:
(d) disposing a first coating layer between the bezel and the reflection layer.

19. The method according to claim 18, further comprising the step of:
(d) disposing a second coating layer disposed onto the reflection layer.

20. The method according to claim 14, wherein the reflection layer comprises a metal material selected from the group consisting of silver (Ag), aluminum (AL), and an alloy of silver and aluminum.
